(19) United States
(12) Patent Application Publication
(10) Pub. No.: US 2008/0260357 A1
(43) Pub. Date: Oct. 23, 2008

(54) OPTICAL DISC DRIVE AND OPTICAL DISC RECORDING METHOD

(76) Inventor: Koichi NAGAI, Chigasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/105,008

(22) Filed: Apr. 17, 2008

(30) Foreign Application Priority Data
Apr. 18, 2007 (JP) 2007-109537

(51) Int. Cl. H04N 7/26

(52) U.S. Cl. 386/124; 386/E05.001

(57) ABSTRACT

According to one embodiment, an optical disk reproducing apparatus which reproduces an optical disk by using an optical disk device which reads data from an optical disk which stores discrete items of data to be read at a specific or higher rate, wherein after start of jumping, regardless of transfer rate, reading is started from a time Ta when a head reaches a jump destination position.

### CROSS-REFERENCE TO RELATED APPLICATIONS

This application is based upon and claims the benefit of priority from Japanese Patent Application No. 2007-109537, filed Apr. 18, 2007, the entire contents of which are incorporated herein by reference.

### BACKGROUND

1. Field

One embodiment of the present invention relates to optical disc apparatuses such as a digital video disc or digital versatile disc (DVD) player, a DVD-ROM drive, and a DVD recorder, an optical disc recording method, and an optical disc.

2. Description of the Related Art

In recent years, an optical disc has been developed in which video, audio, sub-picture or the like are coded and recorded with high density.

Usually video data and audio data are multiplexed in a form of stream data, and recorded on an optical disk, and therefore video data and audio data of the same time are present almost at the same position. In a movie, further, data for subtitle is prepared separately, and multiplexed in the same stream.

When recording information of a movie or the like on an optical disk, editing functions are required for editing after recording in the disk, deleting unnecessary scenes, or shuffling the reproducing sequence. Other functions are also required, such as change of reproducing sequence by the user's operation at the time of reproduction, display of two pictures simultaneously in one screen, for example, a reproduction technology known as picture-in-picture in which a sub-picture is displayed in part of a region of main reproduction video, or multi-angle function of imaging the same object by plural cameras from plural directions, and reproducing it while changing over the reproduction directions by the user's instruction at the time of reproduction.

In such cases, video data and audio data necessary for reproduction are disposed discontinuously on the disk. In the editing operation, a method of recording stream data in the actual sequence of reproduction is known. However, in write-once media, the data once recorded in the disk cannot be edited, and in rewritable or re-recordable media, it takes a long time to reshuffle the data in the actual sequence of production. Accordingly, in the case of editing operation, only the reproduction sequence is recorded separately, and the stream data is read along the reproduction sequence. If the reproduction sequence is changed by user's operation during reproduction, it is of course realized by changing the reading position. In the picture-in-picture display, the recording position is different between the main stream and sub-stream, and thus the two streams are read alternately. In a multi-angle display, when a plurality of data streams are multiplexed, the data rate becomes enormous, and very fast reading is demanded, which is not realistic.

Hence, to realize the multi-angle display without multiplexing and recording the data, the recording structure of data is formed in an interleaved block system. By properly forming the recording structure of interleaved block and properly designing the reproduction processing method, it has been proposed to provide an optical disk reproducing apparatus and method capable of lessening the load of the hardware, and increasing the number of streams easily (see, for example, the specification of Japanese Patent No. 2857119).

The optical disk includes a data region in which data to be decoded is recorded, as well as management data region in which management data necessary for reproducing the recorded data of the data region is recorded. In the multi-angle display, the data region also stores control data. Video signals of a plurality of scenes are divided/distributed into a plurality of interleaved units, respectively. The interleaved units of the respective scenes are mixed/arranged on a recording track to form an interleaved block. The control data is included in each interleaved unit. The control data describe information indicating that the interleaved units are mixed/arranged, and a logical address of the next interleaved unit which is the next jumping end for each scene. Means for controlling a player system for the optical disk comprises means for reading the control data which is included in the interleaved unit every time the interleaved unit is reproduced, and recognizing the information indicating that the interleaved units are mixed/arranged, and the logical address of the next interleaved unit which is the next jumping end for each scene; and means for controlling a read position of the data of the recording medium in such a manner as to change a reproduction stream of the interleaved unit with reference to the logical address of the next interleaved unit for each scene included in the control data, when operation information for scene switching is given. The jumping end of the next interleaved unit for each scene is newly recognized from the control data which is acquired in the read position and which is included in the interleaved unit to wait for the scene switching. By the above-described means, management of the scene switching is facilitated, the burden on the hardware is reduced, design of the recording apparatus is facilitated, and prices are lowered.

In the case of editing operation, the logic address information showing the reproduction sequence is recorded in the management data region, and by using this information, desired data is read by using means for controlling the reading position of data in the recording medium.

In the case of the picture-in-picture display, the data of the main video and the sub-video are read alternately by using the means for controlling the data reading device of the recording medium according to the operation information for video reproduction. In this case, if the main video and sub-video are disposed separately, the reproduction data rate must be low. To assure a sufficient reproduction data rate, it is required to record the main video and the sub-video alternately, but for this purpose, the main video and the sub-video must be reproduced as being synchronized in time. Otherwise, the resolution of the sub-video or the reproduction data rate or length may be provided with certain restrictions before being recorded in a semiconductor memory, and the main video is reproduced from the disk and the sub-video is reproduced from the semiconductor memory at the same time. In this case, it is not required to reproduce the main video and the sub-video in synchronism in time.

An optical disk device reads information by using an optical head, but in order to read the information existing at physically different positions, the optical head is moved radially, and the rotational speed of the disk is controlled depending on the radial position of the head to wait until reaching a desired rotational speed. This operation is called a jump. Data cannot be read during a jump.

On the other hand, the video and audio must be reproduced without interruption, and the main video and the sub-video of a picture-in-picture display must be reproduced simultaneously. Thus, the reproduction data must be supplied continuously in a decoder.

Usually, the data reading speed from the optical disk is almost constant, but since the video data is recorded in a variable rate system, the reading speed from the optical data demanded by the decoder varies. Accordingly, the data must be read intermittently from the optical disk, but the rotation of the optical disk cannot be stopped instantly. Therefore, when resuming the reading operation, a jump called kickback is needed to return the optical head to the reproducing position, and it needs an extra time.

To absorb such difference in reading speed, the reproduction data read from the optical disk is once stored in a track buffer memory. The size of the track buffer memory is determined by the quantity of data demanded by the decoder while suspending reading from the optical disk. Before the reading is suspended, enough data must be stored in the track buffer memory, and this is realized by taking advantage of difference between the reading rate of the optical disk, and the video data rate output from the track buffer memory. Therefore, the data must be read continuously from the optical disk before the time of the jump. As a result, the minimum size of the data to be read from the optical disk is determined before the jump.

The size of the interleaved unit is determined so that the data may be output continuously from the track buffer memory, that is, the data may be supplied into the decoder without interruption. The size of the track buffer memory is determined so that the output data of the track buffer memory may not be interrupted even if the interleaved unit jumps successively to the kickback operation of the reproducing device.

The DVD standard operating on this technology (see, for example, ECMA-267 120 nm DVD-Read-Only Disk) is widely used and gaining high reputations. Recently, the display and information recording medium for household use corresponding to high definition (HD) images have been widely used. The conventional DVD-Video standard and VIDEO Recording standard are capable of recording a movie of standard definition (SD) with standard length in a single-layer DVD-ROM, but by the recent progress in moving image compression technology, high definition (HD) video of about 4× pixel density can be compressed to an average of 2× data quantity, so that a movie may be stored in a dual-layer DVD-ROM. That is, the data quantity is 2× on average, or 3 times the data quantity in part. Therefore, the data rate Vo supplied from the track buffer memory to the decoder is 3 times the conventional quantity, and the data rate Vr to be read from the disk and supplied into the track buffer memory is required to be 3 times the conventional rate.

Most optical disks including the DVD-ROM are constant in the linear recording density, and thus in order to read the information at a constant data rate Vr, the rotational speed must be changed depending on the radius. This is realized by controlling the spindle motor, but supposing the torque of the spindle motor to be constant, the time required to change the rotational speed at the same radius is almost proportional to the data rate Vr and jump distance. Actually, as the general characteristics of the motor, as the rotational speed increases, the resistance of viscosity and the wind loss are increased. Therefore, as the rotational speed increases, the torque available for increase in disk rotational speed decreases, and the torque is further decreased by the back-EMF.

In the conventional DVD-Video standard and Video Recording standard, it was possible to follow up the disk rotational speed by the end of the jump, but by such demand of 3 times the disk rotational speed, it is difficult to increase the torque of the spindle motor. Thus, even if the jump is over, it is difficult to maintain the linear velocity, that is, the reading speed. In particular, in a portable appliance which operates on a battery, the peak electric power is limited. To increase the peak electric power, the battery size must be increased, that is, the size and weight of the appliance must be increased, and a commercial value is spoiled. It is hence not realistic to increase the motor torque.

Specifically, when jumping from the outer area to the inner area in reproduction, the disk rotational speed must be increased, but if not possible to follow up the speed due to lack of torque, the data rate Vr may be lower than the assumed standard value, the track buffer memory may be vacant, and the video may be interrupted.

In the present DVD drive capable of reproducing at high speed, the disk recorded at a constant linear velocity (CLV) may be rotated at a constant angular velocity (CAV) instead of the constant linear velocity. In this case, since the reading data rate Vr is 3× or more, if the innermost area is 3×, the linear velocity of the outermost area is about 7.3×, thereby solving the problem described above.

However, in the existing DVD-ROM, the reading speed guaranteed by the standard is 1× speed, and the mechanical characteristics such as warp or eccentricity of disk are determined by assuming reproduction at 1× speed. If the disk is warped or eccentric, an objective lens actuator must generate a force for following up, but the acceleration generated by warp or eccentricity is proportional to the square of the linear velocity. For example, at 8× speed, it is required to generate a force of 64 times 1× speed. Realistically, it is difficult to generate such enormous force. Therefore, even in a drive capable of reproducing at high speed, fast reproduction is difficult due to mechanical properties such as warp of disk, and the reproducing speed is lowered in such a case. In other words, as long as the warp or eccentricity of the disk is small enough as compared with the standard, fast reproduction is possible. If it is large, however, it is impossible to follow up, and the reproducing speed must be lowered.

In a disk capable of recording high definition (HD) video, the maximum values of warp and eccentricity of the disk must be determined so as to reproduce at 3× speed, but considering the present disk manufacturing technology, aging effects, cost, and the performance and cost of optical disk device, it is not realistic to determine the standard so as to reproduce by the CAV system in which the innermost area is 3× speed, and the problem described above cannot be solved by reproducing by the CAV system.

Accordingly, as the measure for jumping a relatively short distance at the time of interleaving or the like, a technology for preventing drop of transfer rate has been developed (see, for example, Jpn. Pat. Appln. KOKAI Publication No. 2006-48735). In this system, prior to the jump, the reading data rate is set slightly higher than the Vr, and the data rate is prevented from becoming lower than the Vr after the jump. After the jump, to be ready for a next jump, the reading data rate must be set slightly higher than the Vr again, and hence it is required to limit the time interval of jumps, and the restriction must be added for the lower limit size of the interleaved unit.

In this method, however, when jumping a long distance between two arbitrary points in the VIDEO standard or VIDEO Recording standard for high definition specification, the difference in rotational speed is too large before and after the jump, and the reading data rate Vr is higher to be closer to the CAV system, which is not realistic.

Thus, in the conventional optical disk device for HD video, the disk rotational speed must be increased, but when jumping a long distance between two arbitrary points of the disk, the writing data rate from the disk to the reading track buffer memory may not be kept constant, and the video may be interrupted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory view showing a region structure on a DVD-ROM disc according to the present embodiment;

FIG. 2 is an explanatory view showing a data structure in a lead-in area of the DVD-ROM disc of FIG. 1;

FIG. 3 is a detailed explanatory view of contents of physical format information of FIG. 2;

FIGS. 4A, 4B and 4C are explanatory views showing a logical sector number setting method of DVD-ROM (single-layer, dual-layer disc);

FIG. 5 is an explanatory view showing a volume space of an optical disc;

FIG. 6 is an explanatory view showing structures of a video manager VMG and a video title set VTS in more detail;

FIG. 7 is an explanatory view showing a relation between a video object set VOBS and a cell, and further contents of the cell in a hierarchical manner;

FIG. 8 is an explanatory view showing an example in which a reproduction order of cells is controlled by a program chain PGC;

FIG. 9 is an explanatory view showing a relation between a video object unit VOBU and video packs in this unit;

FIG. 10 is an explanatory view showing an example in which interleaved blocks are arranged;

FIG. 11A is an explanatory view showing an example of a recorded state in which each of video objects of scenes of Angles 1 and 2 is divided into three interleaved units (ILVU1-1 to ILVU3-1), (ILVU1-2 to ILVU3-2) and arranged on one track;

FIG. 11B is an explanatory view showing an example of a reproduction output in the reproduction of Angle 1;

FIG. 12 is a constitution diagram of an optical disc recording apparatus according to a first embodiment of the present embodiment;

FIG. 13 is an explanatory view showing the optical disc recording apparatus shown in FIG. 12 in a simplified manner;

FIG. 14 is an explanatory view showing a recording unit of information recorded into a data area;

FIG. 15 is an explanatory view showing increase/decrease of a data input into a track buffer memory at a time when the interleaved block is reproduced in a worst case;

FIG. 16 is an explanatory view showing a time when a kickback operation is performed in the recording apparatus, and subsequently a maximum class of jumping operation is performed, and a situation in which data is reduced in the track buffer memory;

FIG. 17 is a schematic diagram showing changes of a transfer rate from an optical disk which is defined in the conventional optical disk;

FIG. 18 is a schematic diagram showing changes of a transfer rate from an optical disk according to an embodiment of the present invention to prevent a track buffer memory from being run short; and

FIG. 19 is a schematic diagram showing changes of a transfer rate from an optical disk and an amount of data stored in the track buffer according to an embodiment of the present embodiment.

### DETAILED DESCRIPTION

Embodiments of an optical disc drive and an optical disc recording method according to the present invention will be described hereinafter with reference to the drawings. In general, according to one embodiment of the invention, an optical disk reproducing apparatus which reproduces an optical disk by using an optical disk device which reads data from an optical disk which stores discrete items of data to be read at a specific or higher rate, wherein after start of jumping, regardless of transfer rate, reading is started from a time Ta when a head reaches a jump destination position.

### First Embodiment

At present, there have been developed an optical disc in which video, audio, sub-picture or the like is encoded and recorded at a high density (hereinafter referred to simply as the optical disc), and an optical disc drive which is a recording/reproducing apparatus. To record information such as movies in this optical disc, a plurality of simultaneously proceeding stories are recorded, or a multi-angle scene is recorded in which the same simultaneously proceeding event is photographed from a plurality of angles, so that an audience can freely select the scene from them. This type of optical disc has been developed.

Outlines will be first described with respect to a DVD standard optical disc having these functions and put to practical use at present, and a recording apparatus for the disc.

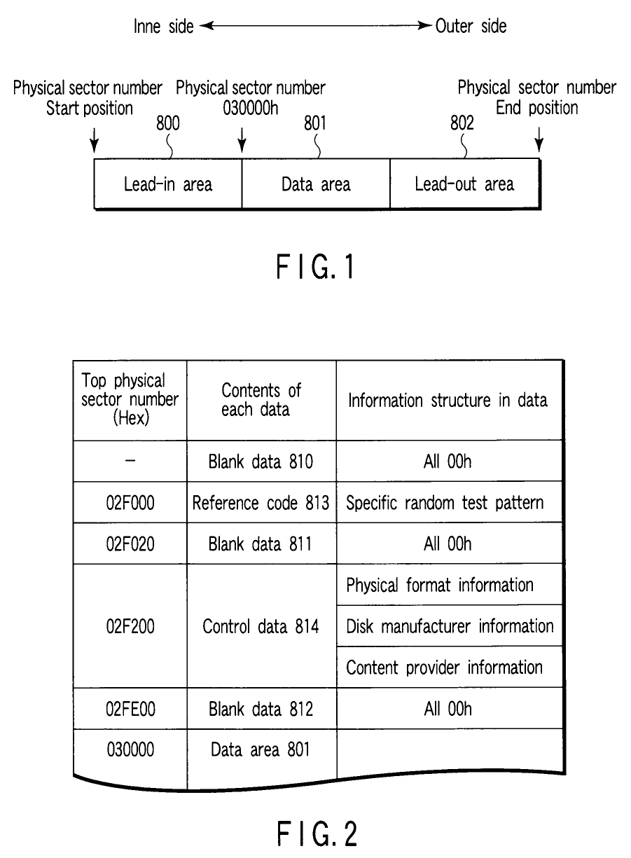

FIG. 1 shows a region structure of a DVD-ROM disc. A lead-in area 800, a data area 801, and a lead-out area 802 are arranged in order from an inner peripheral side toward an outer peripheral side of a disc-shaped information storage medium. In the DVD-ROM disc, information is recorded as a set every 2048 bytes, and this minimum recording unit is called a sector. A physical sector number is set to each sector, and this physical sector number is recorded on a recording surface of the DVD-ROM disc as described later. A physical sector number start position agrees with a start sector of the lead-in area 800 in an innermost area of the information storage medium, and continuous physical sector numbers are set in an ascending order toward an outer area. In the first sector of the data area 801, the physical sector number is determined beforehand in such a manner as to be set to 030000h (h means hexadecimal rotation).

FIG. 2 shows a data structure in the lead-in area 800 of the DVD-ROM disc. There are a reference code 813 which indicates a reference signal, and a control data 814. Among the data, blank data 810, 811, 812 exist in which all 00h is recorded.

In the reference code 813, a specific random test pattern is recorded, and adjustment of an information recording apparatus is possible such as parameter adjustment of an automatic equalizer using the information. In the control data 814, information are recorded as described later: physical format information which is format information inherent in the information storage medium; disc manufacturing information in which information on manufacturing is recorded such as a manufacturing number of each information storage medium; and contents provider information indicating information on information contents recorded in the data area 801.

The physical sector number of the top sector is 02F000h in which the reference code 813 is recorded, and the physical sector number of the top sector is 02F200h in which the control data 814 is recorded.

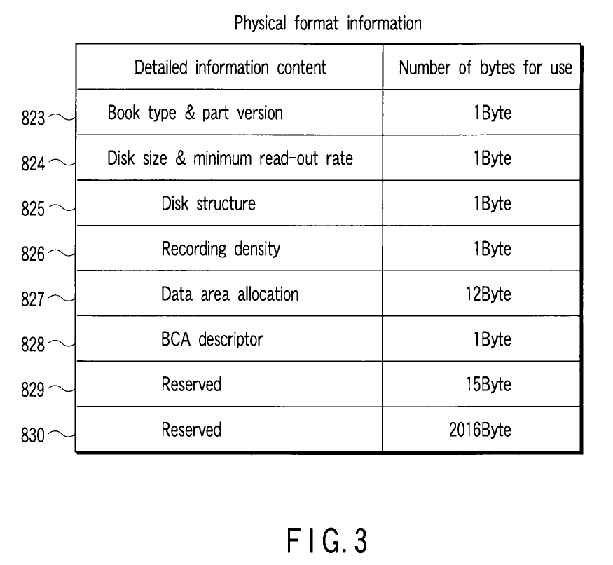

As shown in FIG. 3, in the physical format information, information are recorded: a book type and part version 823 indicating applied DVD standard types (DVD-ROM/DVD-RAM/DVD-R, etc.) and a part version; a disc size and minimum read-out rate 824 indicating a disc size and a minimum read-out rate; a disc structure 825 showing a disc structure such as a single-layer ROM disc/single-layer RAM disc/dual-layer ROM disc; a recording density 826 indicating a recording density; a data area allocation 827 indicating a position in which data is recorded; a burst cutting area (BCA) descriptor 828 in which a manufacturing number or the like of each information storage medium is recorded in a non-rewritable form on the inner peripheral side of the information storage medium; and reserved 829, 830 in which future use is predicted and a reserved place is designated.

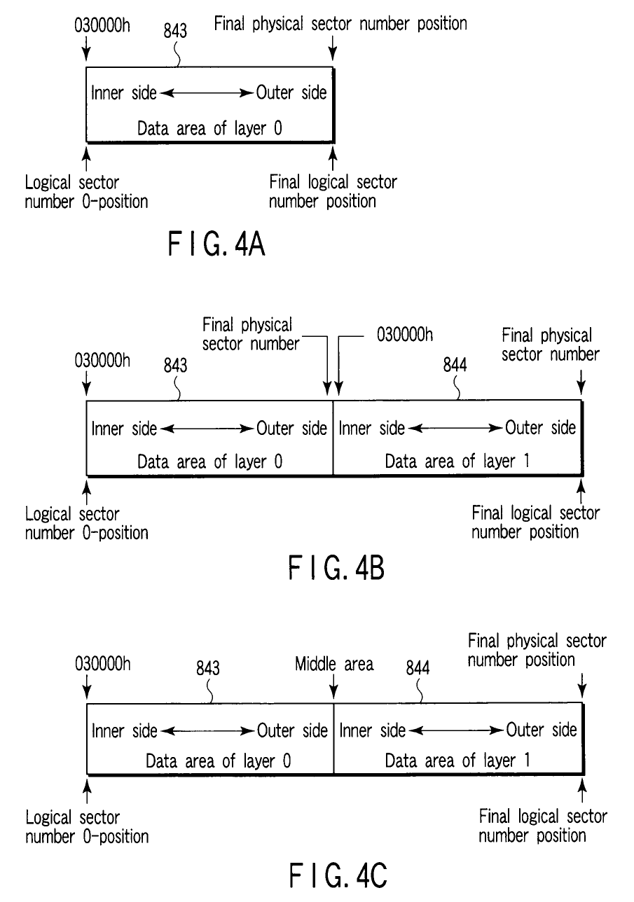

FIGS. 4A to 4C show a logical sector number setting method in the DVD-ROM disc having a single-layer or dual-layer structure. A physical sector number PSN indicates a method of setting an address to a sector unit, in which a sector number is uniquely set to each layer of the recording surface of the information storage medium (DVD-ROM disc or DVD-RAM disc), and the physical sector number is recorded on the recording surface. On the other hand, a logical sector number LSN indicates a method (address setting of the sector unit) in which the whole is regarded as one volume space with respect to the information storage medium having the recording surface comprising a single layer or a plurality of layers, and an integrated address is set. The logical sector number merely indicates a systematic number setting method, and is not directly recorded in the recording surface of the information storage medium unlike the physical sector number.

FIG. 4A is an explanatory view of the method of setting a logical sector of a DVD-ROM disc having a recording surface which has the region structure shown in FIG. 1 and which has only a single layer. In FIG. 4A, a 1:1 correspondence is established between the physical sector number PSN and the logical sector number LSN in a volume space from the lead-in area 800 to the lead-out area 802.

FIGS. 4B and 4C are explanatory views of a method of setting the logical sector of the DVD-ROM disc in which dual layers exist in the recording surface having the region structure shown in FIG. 1.

In the volume space in which dual layers are integrated as shown in FIG. 4B, a data area 843 of layer 0 is arranged in an area whose physical sector number PSN is smaller (first half of the volume space), and a data area 844 of Layer 1 is arranged in an area whose physical sector number PSN is larger (last half of the volume space). A setting position of the logical sector number LSN is set in such a manner that a sector of Layer 1, having physical sector number 030000h, continuously follows a final physical sector number position in the data area 843 of Layer 0. As a result, the physical sector number PSN of Layer 0 of the first half, and the physical sector number PSN of Layer 1 of the last half are associated with the logical sector number LSN of a single volume space.

FIG. 4C is an explanatory view of a method of setting another logical sector number. This setting method is the same as that of FIG. 4B in that the data area 843 of Layer 0 is arranged in the first half (=first half of the logical sector number) of the volume space, and the data area 844 of Layer 1 is arranged in the last half (=last half of the logical sector number) of the volume space. However, in the setting method of FIG. 4C, the arrangements of both Layers 0 and 1 in the region structure are different from those shown in FIG. 1. That is, in Layer 0, a lead-out area 802 position of FIG. 1 is changed to a middle area 848. In Layer 1, the lead-out area 802 is arranged in a lead-in area 800 position arranged on the inner peripheral side of FIG. 1, and the middle area 848 is arranged in a lead-out area 802 position arranged on the outer peripheral side of FIG. 1. Furthermore, in Layer 1, the physical sector numbers are all set/recorded in an ascending order from the outer peripheral side toward the inner peripheral side in any of the data area 801, lead-out area 802, and middle area 848. The logical sector number of Layer 0 is continuously connected to that of Layer 1 in the middle area 848 between the layers.

The last physical sector number of the data area in Layer 0 is recorded in the data area allocation 827 in the physical format information shown in FIG. 3. The minimum physical sector number is arranged at the outermost area of the data area of Layer 1, and represented by a value obtained by bit-reversing the last physical sector number arranged at the outermost area of the data area of Layer 0, that is, a complement of one. The number indicates a negative value. Therefore, the logical sector number can be converted to the physical sector number. When an absolute value of the physical sector number of Layer 0 is equal to that of the physical sector number of Layer 1, there is also a characteristic that the position has a substantially equal distance from a disc center.

In the arrangement of FIG. 4C, there is a characteristic that a ratio of the distance in the logical sector number to a sector interval on the physical disc is constant. Whereas it is not in the arrangement of FIG. 4B. For example, in the system of FIG. 4B, an optical head has to move from a disc outermost area to an innermost area even at the time of moving to the first sector of Layer 1 next to the last sector of Layer 0, that is, by one sector. On the other hand, in the system of FIG. 4C, a change of a radial position may be approximately a manufacturing error. This characteristic has an effect of preventing a necessary coarse access (details will be described later) from being lengthened, and suppressing a capacity increase or the like of a track buffer described later in the recording of information indicating that video needs to be prevented from being interrupted as in the reproduction of a movie.

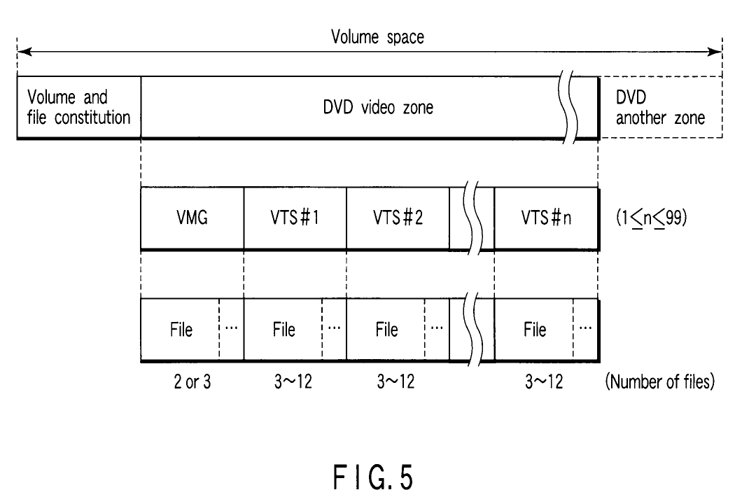

FIG. 5 shows a volume space of a DVD-ROM disc in which video data is recorded like a movie. The volume space comprises a volume and file constitution zone, a DVD video zone, and another zone. In the volume and file constitution zone, a universal disk format specification revision 1.02 (UDF) bridge constitution is described, the data is read even by a computer having a predetermined standard. The DVD video zone has a video manager VMG, and n (1 to 99) video title sets VTS. Each of the video manager VMG and the video title sets VTS comprises a plurality of files. The video manager VMG is information for controlling the video title sets VTS.

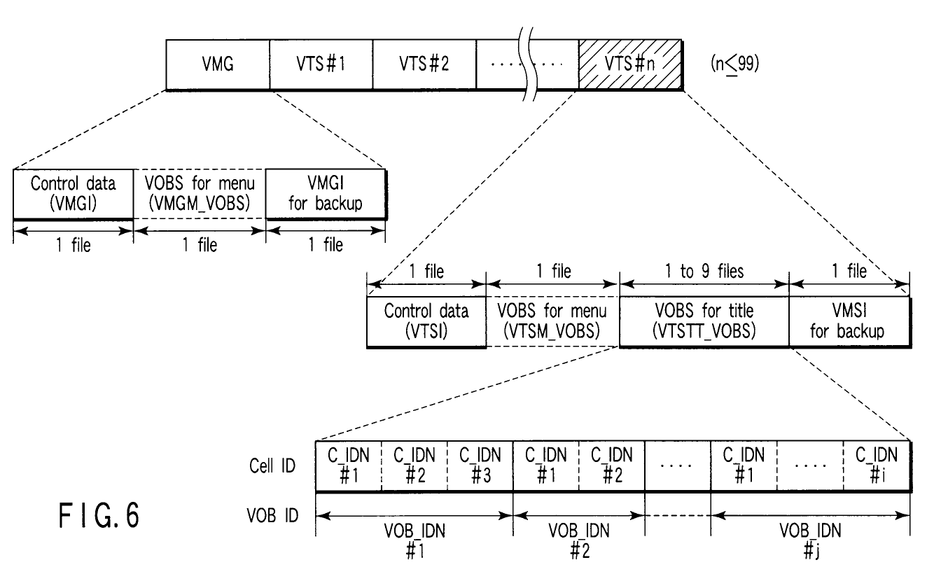

FIG. 6 shows structures of the video manager VMG and the video title set VTS in more detail.

The video manager VMG has video manager information VMGI which is control data, and a video manager video object set VMGM_VOBS which is data for menu display. The video manager VMG also has video manager information VMGI for backup, whose contents are the same as those of the video manager information VMGI.

The video title set VTS has video title set information VTSI which is control data, a video title set video object set VTSM_VOBS which is data for menu display, and a video title set video object set VTSTT_VOBS for a title of the video title set which is a video object set for video display. The video title set VTS also has, for backup, video title set information VTSI whose contents are the same as those of the video title set information VTSI.

Furthermore, a plurality of cells constitute the video title set video object set VTSTT_VOBS which is a video object set for the video display. An ID number is assigned to each cell.

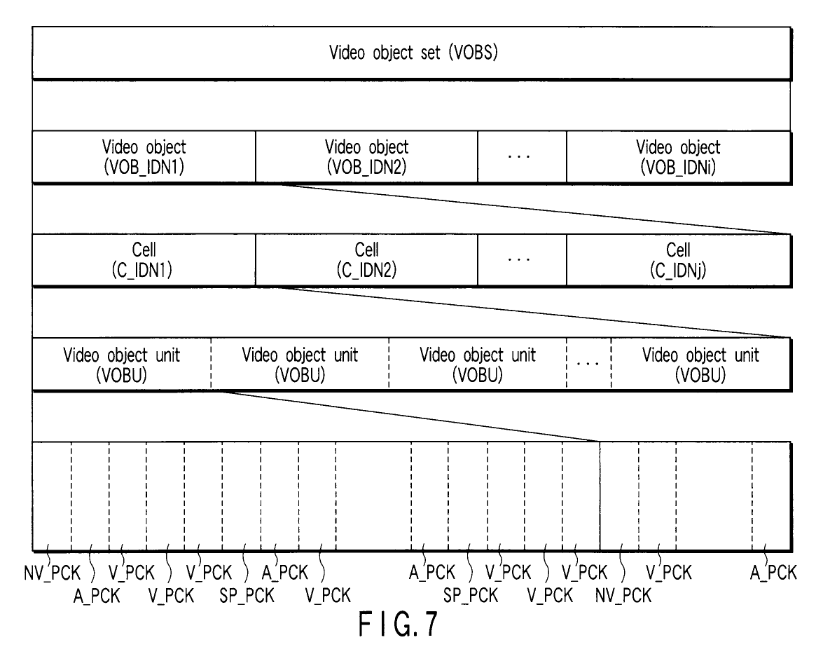

FIG. 7 shows a relation between the video object set VOBS and the cell, and contents of the cell in a hierarchical manner. When the DVD is reproduced, video segmentation (scene change, angle change, story change, etc.) or special reproduction is controlled in accordance with a cell unit or a video object unit VOBU which is a lower layer of the cell, further an interleaved unit ILVU.

The video object set VOBS comprises a plurality of video objects VOB_IDN1 to VOB_IDNi. One video object VOB comprises a plurality of cells C_IDN1 to C_IDNj. One cell comprises a plurality of video object units VOBU, or an interleaved unit ILVU described layer. One video object unit VOBU comprises one navigation pack NV_PCK, a plurality of audio packs A_PCK, a plurality of video packs V_PCK, and a plurality of sub-picture packs SP_PCK.

The navigation pack NV_PCK is mainly used as control data for controlling reproduction/display of data in the video object unit VOBU to which the navigation pack belongs, and control data for searching data in the video object unit VOBU. The video pack V_PCK is main picture information, and is compressed by standards such as MPEG-4. The sub-picture pack SP_PCK is sub-picture information having auxiliary contents with respect to a main video. The audio pack A_PCK indicates audio information.

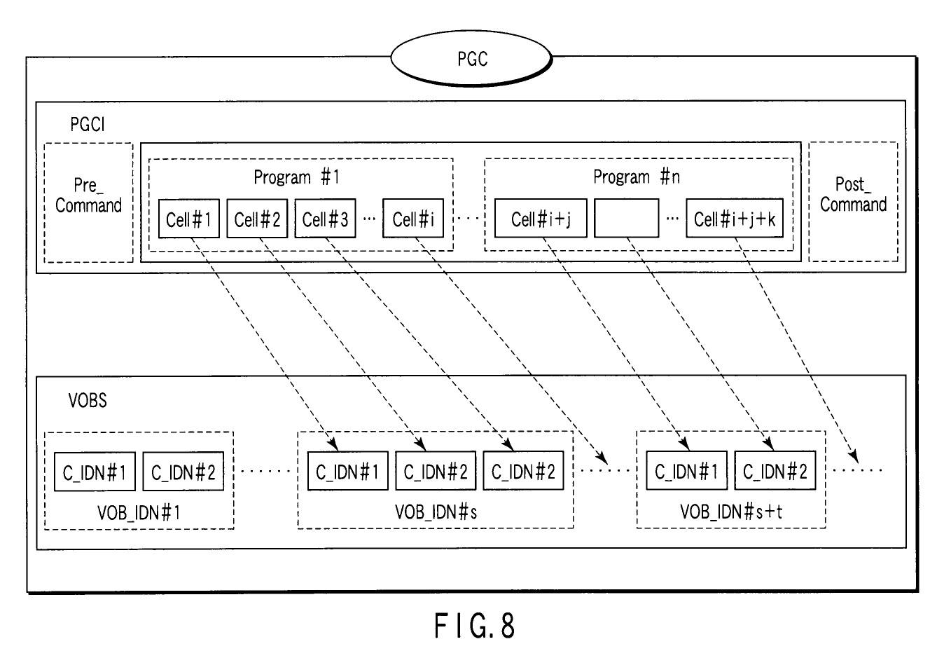

FIG. 8 shows an example in which the reproduction order of the plurality of cells is controlled by a program chain PGC.

As the program chain PGC, various program chains PGC#1, PGC#2, PGC#3, . . . are prepared in such a manner that various reproduction orders of data cells can be set. Therefore, when the program chain is selected, the cell reproduction order is set.

An example is shown to execute programs #1 to #n described by program chain information PGCI. The shown program has contents to designate the cell designated by C_IDN#1 of VOB_IDN#s in the video object set VOBS and the subsequent cells in order. The program chain is recorded in a management information recording section of the optical disc, read prior to reading of the video title set of the optical disc, and stored in a memory of a system control section. Management information is arranged in the video manager and the top of each video title set.

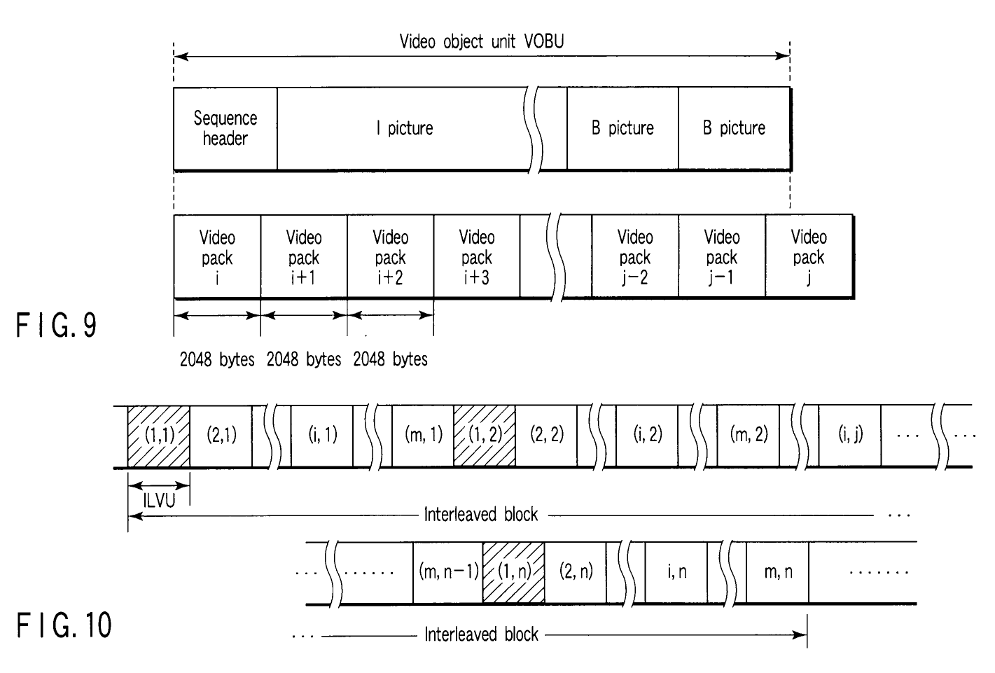

FIG. 9 shows a relation between the video object unit VOBU and video packs in this unit. The video data in the video object unit VOBU comprises one or more groups of pictures GOP. The encoded video data conforms to, for example, ISO/IEC13818-2. The group of pictures GOP of the video object unit VOBU comprises I and B pictures, and continuity of this data is divided into video packs.

Next, a data unit will be described in a case where multi-angle information is recorded/reproduced. When a plurality of scenes having different points of view with respect to a subject are recorded in the disc, an interleaved block section is constructed on a recording track in order to realize seamless playback. In the interleaved block section, each of a plurality of video objects VOB having different angles are divided into a plurality of interleaved units ILVU, arranged, and recorded in such a manner that the seamless playback is possible as described above. The interleaved block will be hereinafter referred to as the interleaved unit.

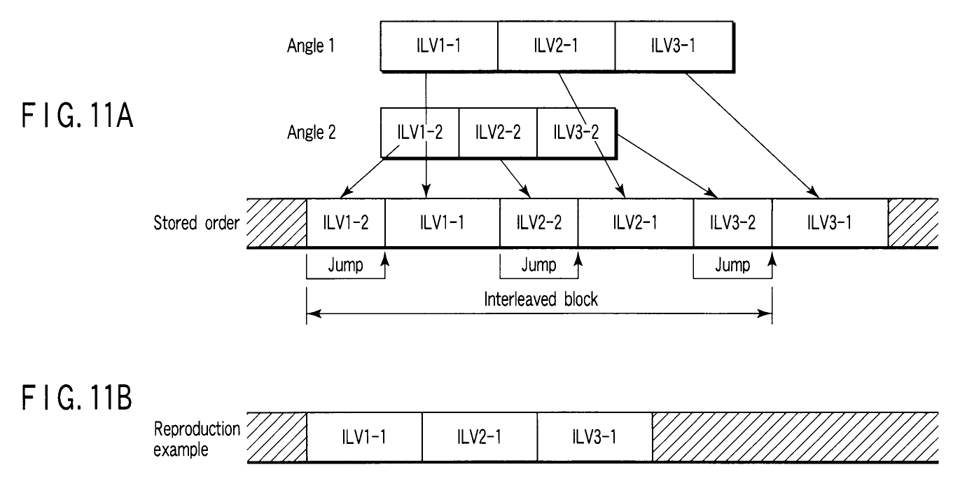

FIG. 10 shows an arrangement example of the interleaved units ILVU. In this example, one or each of m video objects VOBs is divided into n interleaved units ILVUs, and arranged. Each video object VOB is divided as the same number of interleaved units ILVUs.

FIGS. 11A and 11B show a recorded state in which, for example, each of two video objects VOBs, that is, each of video objects VOBs of scenes of Angles 1 and 2 is divided into three interleaved units ILVU1-1 to ILVU3-1; ILVU1-2 to ILVU3-2, and arranged on one track, and a reproduction output example in which Angle 1 is reproduced. In this case, information of Angle 2 is not taken in.

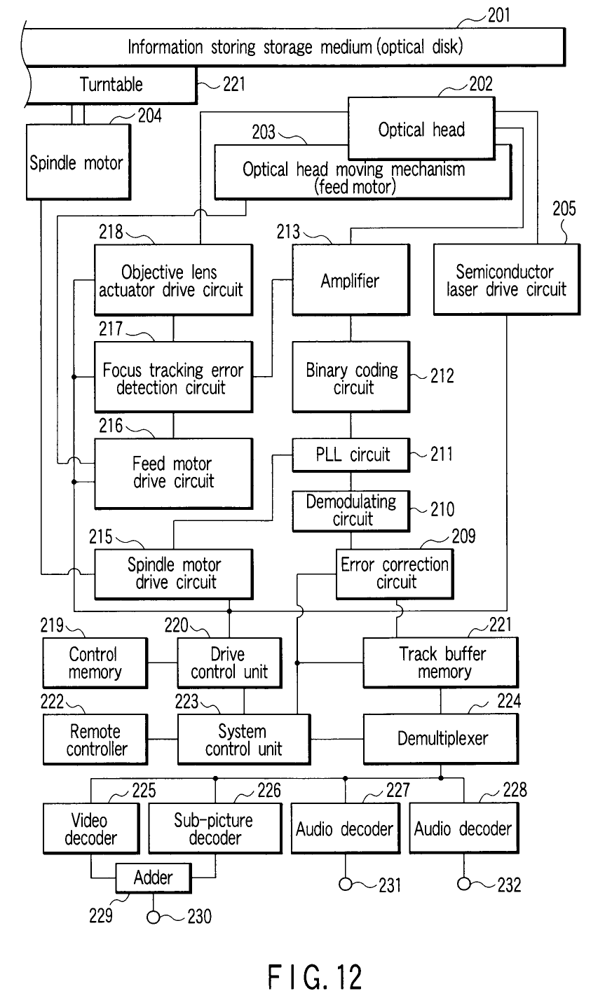

FIG. 12 is a block diagram of an optical disk reproducing apparatus capable of reproducing the DVD-ROM disk. In this optical disk reproducing apparatus, the pre-recorded information is reproduced from a specified position on an information recording medium (optical disk) 201 by using a focusing spot. As the means for achieving this fundamental function, the focusing spot is traced (to follow) along the track (not shown) on the information recording medium 201. Although not shown, an optical head 202 has incorporated therein a photo detector for detecting the quantity of light generated from a semiconductor laser element. In a semiconductor laser driving circuit 205, the difference between the output of the photo detector (a detection signal of quantity of light generated from the semiconductor laser element) and a constant quantity of light necessary for reproduction is calculated, and on the basis of the calculated result, a driving current is fed back to the semiconductor laser element in the optical head 202.

The optical disk 201 is mounted on a turntable 221, and is rotated and driven by a spindle motor 204. Now supposing to be in a reproduction mode, the information recorded in the optical disk 201 is picked up by the optical head 202. The optical head 202 is moved in the disk radial direction as an optical head moving mechanism 203 is driven by a feed motor drive circuit 216.

The optical head 202 is, although not shown, basically composed of a semiconductor laser element as a light source, a photo detector, and an objective lens.

The laser light emitted from the semiconductor laser element is focused on the information recording medium (optical disk) 201 by the objective lens. The laser light reflected by a light reflection film of the information recording medium (optical disk) 201 is photo-electrically converted by the photo detector.

The detection current obtained in the photo detector is converted into a voltage by an amplifier 213, and a detection signal is obtained. This detection signal is processed in a focus/tracking error detection circuit 217 or a binary coding circuit 212. Generally, the photo detector is divided into a plurality of light detection regions, and changes in quantity of light emitted to the light detection regions are individually detected. The individual detection signals are added and subtracted in the focus/tracking error detection circuit 217, and focus deviation and track deviation are detected. The reflected light quantity change from the light reflection film of the information recording medium (optical disk) 201 is detected, and the signal on the information recording medium 201 is reproduced.

The objective lens (not shown), which focuses the laser light emitted from the semiconductor laser element on the information recording medium 201, is mounted on an objective lens actuator (not shown). Depending on the output current of an objective lens actuator drive circuit 218, the lens is designed to move in two axial directions, i.e., perpendicular to the information recording medium 201 for correction of focus deviation, and radially relative to the information recording medium 201 for correction of track deviation. Usually it is designed to move by an electromagnetic driving system using a permanent magnet and a coil.

For correction of focus deviation or for correction of track deviation, the objective lens actuator drive circuit 218 is responsible for supplying a drive current to the objective lens actuator (not shown) in the optical head 202 according to the output signal (detection signal) of the focus/tracking error detection circuit 217. To move the objective lens by high speed response up to a high frequency range, it is provided with a phase compensation circuit for improving the characteristics depending on the frequency characteristics of the objective lens actuator.

The objective lens actuator drive circuit 218, according to a command from a control unit 220, controls to turn on or off the focus/track deviation correction action (focus/track loop), to move the objective lens at low speed in the direction (focus direction) perpendicular to the information recording medium 201 (to be executed when the focus/track loop is off), or to move the focusing spot to a nearby track by slightly moving the lens radially (the track crossing direction) of the information recording medium 201 by using a kick pulse.

The linear velocity of the information recording medium 201 is detected by a reproduction signal obtained from the information recording medium 201. That is, the detection signal (analog signal) from the amplifier 213 is converted into a digital signal in the binary coding circuit 212, and from this signal, a constant period signal (reference clock signal) is generated in a PLL circuit 211. A spindle motor drive circuit 215 determines the difference between the target linear velocity obtained from a drive control unit 220 and the constant period signal (the present linear velocity), and supplies a drive current to the spindle motor 204 according to the result, thereby controlling the rotation of the spindle motor 204.

When reading the information at a specific position on the information recording medium 201, usually, it is processed in two steps, that is, coarse access process and fine access process.

In the coarse access process, first, the radial position of an access destination is determined by calculation, and the distance thereto from the present position of the optical head 202 is obtained. The velocity curve information for reaching the moving distance of the optical head 202 in the shortest time is preliminarily recorded in a control semiconductor memory 219. The control unit 220 reads this information, and controls to move the optical head 202 according to a method described below along this velocity curve. The control unit 220 sends a command to the objective lens actuator drive circuit 218 to turn off the track loop, and controls the feed motor drive circuit 216 to thereby start to move the optical head 202. When the focusing spot crosses the track on the information recording medium 201, a track error detection signal is generated in the focus/tracking error detection circuit 217. Using this track error detection signal, the relative speed of the focusing spot with respect to the information recording medium 201 can be detected. The feed motor drive circuit 216 sequentially calculates the difference between the relative speed of the focusing spot obtained from the focus/tracking error detection circuit 217, and the target speed information sequentially sent from the control unit 220, and feeds back the result to the drive current to the optical head drive mechanism (feed motor) 203, thereby moving the optical head 202. When the optical head 202 reaches the target position, the control unit 220 sends a command to the objective lens actuator drive circuit 218, thereby turning on the track loop.

In this coarse access process, due to detection error or the like, the focusing spot reaches a position slightly deviated from the target track, and it is successively followed by a fine access process. First, while tracing the focusing spot along the track on the information recording medium 201, the address or the track number of the area is reproduced. Herein, from the address or the track number, the present position of the focusing spot is determined, the number of error tracks from the target position to be reached is calculated in the control unit 220, and the number of tracks necessary for moving the focusing spot is noticed to the objective lens actuator drive circuit 218. In the objective lens actuator drive circuit 218, when a set of kick pulses is generated, the objective lens is slightly moved radially relative to the information recording medium 201, and the focusing spot is moved to an adjacent track. In the objective lens actuator drive circuit 218, the track loop is temporarily turned off, and the number of kick pulses corresponding to the information from the control unit 220 is generated, after which the track loop is turned on again. After the fine access, the control unit 220 reproduces the information of the position being traced by the focusing spot (or the address or track number), and confirms that the target track is being accessed. If deviated yet, the fine access is repeated until reaching as specified.

If the difference is slight between the radial position of the access destination and the present radial position, it is adjusted by the fine access process only.

As shown in FIG. 12, the track error detection signal output from the focus/tracking error detection circuit 217 is also input into the feed motor drive circuit 216. At the time of “access control” mentioned above, it is controlled by the control unit 220 so as not to use the track error detection signal in the feed motor drive circuit 216. By confirming that the focusing spot has reached the target track by the access, the control unit 220 sends a command, and part of the track error detection signal is supplied as a drive current to the optical head drive mechanism (feed motor) 203 by way of the motor drive circuit 216. This control continues during the period of continuous reproduction process. By performing reproduction or recording/erasing process for a long time continuously, the position of the focusing spot is gradually moved in the outer circumferential direction or inner circumferential direction. When part of the track error detection signal is supplied as drive current to the optical head moving mechanism (feed motor) 203, accordingly, the optical head 202 is gradually moved in the outer circumferential direction or inner circumferential direction. Thus, the track deviation correction range of the objective lens actuator may be limited to a very small range.

Further, a demodulator circuit 210 and an error correction circuit 209 are provided for the purposes of correcting the recorded information error, arising from defects on the information recording medium 201, of the signal to be recorded on the information recording medium 201, and for simplifying the reproduction processing circuit by rendering the direct-current component of reproduction signal to zero, and recording the information at as high a density as possible on the information recording medium 201. The change in the quantity of reflected light from the light reflection film of the information recording medium (optical disk) 201 is detected, and the signal on the information recording medium 201 is reproduced and amplified by the amplifier 213. This signal has an analog waveform. In the binary coding circuit 212, this signal is converted by a comparator into binary digital signals consisting of “1” and “0”.

From the obtained reproduction signal, a reference signal for reproducing information in the PLL circuit 211 is taken out. The PLL circuit 211 incorporates a frequency variable oscillator. The frequency and phase are compared between the pulse signal (reference clock) output from the oscillator and the output signal from the binary coding circuit 212, and the result is fed back to the oscillator output. A conversion table showing the relation between modulated signal and demodulated signal is incorporated in the demodulator circuit 210, and while referring to the conversion table according to the reference clock obtained in the PLL circuit 211, the signal is returned to the original signal and is sent to the error correction circuit 209.

The error correction circuit 209 has a semiconductor memory, and corrects an error when data is accumulated in an error processing unit, and outputs the data to the transfer buffer memory 221.

A demultiplexer 224 reads data from the track buffer memory 221, and separates the data into video information, subtitle and text information, audio information, control information and others, and sends them out. This is because the disk 201 contains the subtitle and text information (sub-picture), audio information, and others recorded corresponding to the video information. In this case, as the subtitle and text information or audio information, various languages may be selected, and may be selected according to the control of the system control unit 223. Operation input by the user is given to the system control unit 223 through a remote control operation unit 222.

The video information separated by the demultiplexer 224 is input into a video decoder 225, and is decoded according to the system of the display device. For example, the information is converted into NTSC, PAL, SECAM, wide screen, and others. The sub-picture separated by the demultiplexer 224 is input into a sub-picture decoder 226, and is decoded as subtitle or text video. The video signal decoded in the video decoder 225 is input to an adder 229, and summed with subtitle and text video (=sub-picture), and the summed output is sent out to an output terminal 230. The audio signal selected and separated by the demultiplexer 224 is input into an audio decoder 227, demodulated, and sent out to an output terminal 231. The audio processing unit includes an audio decoder 228 aside from the audio decoder 227, and the audio of other language may be reproduced and sent out to an output terminal 232.

As mentioned above, usually, the data reading speed is almost constant, but the video data is recorded at variable rate, and thus the reading speed demanded by the decoder 225 varies. When recorded in multi-scene system, the data is not recorded continuously on the disk but is recorded intermittently. Thus, while the data is not read continuously, the decoder 225 requires the data continuously. To absorb this difference, the reproduction data is once stored in the track buffer memory 221, and is then supplied to the demultiplexer 224 depending on the decoding speed. In usual continuous reproduction, if data stored in the track buffer memory 221 overflows, the system control unit 223 kicks back. The kickback process is to read again the data for the portion of the specified sectors having been read so far, and is a function of compensating for data deficiency even if data overflow occurs in the track buffer memory 221.

When an optical disk including multi-story is reproduced, as the disk management information, choices of multi-story are displayed as menu on the monitor screen or sub-display unit of the system. While referring to the menu, the user may preliminarily select a branch story through the remote control operation unit 222. When the selection information is given, the system control unit 223 obtains the identification information of the branch story, and the data having the identification information added to the header is extracted from the track buffer memory 221, and is given to the demultiplexer 224.

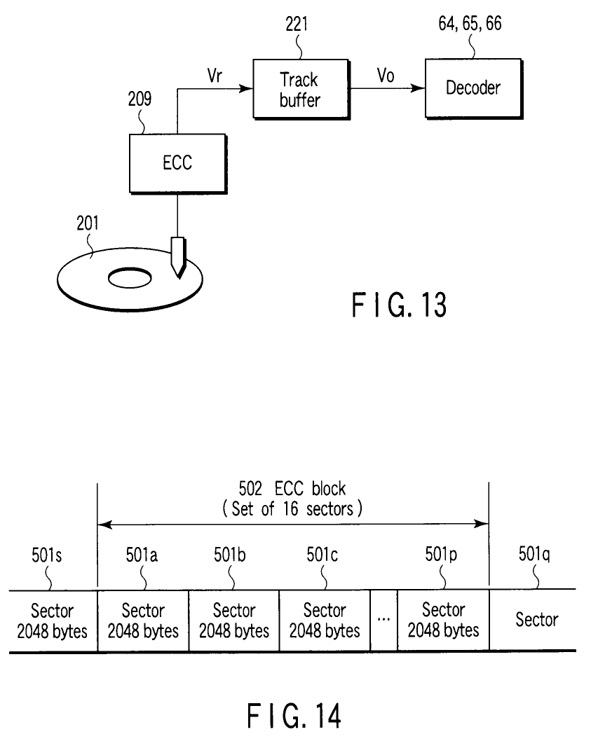

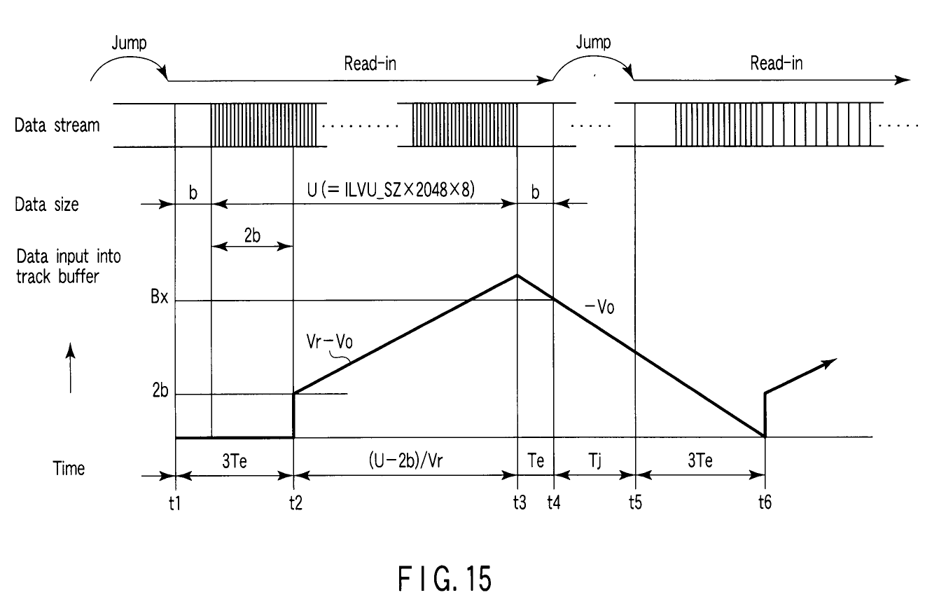

FIG. 13 is a diagram showing a reproducing part of the recording/reproducing apparatus shown in FIG. 12. When the jumping reproduction is performed, data needs to be supplied to the decoders 64, 65, 66 without being interrupted. Therefore, a track buffer (temporary storage unit 37) 221 is connected. Moreover, Vr denotes a transfer rate (read-out rate from the optical disc) of the data supplied from an error correction (ECC) process unit 209 to the track buffer 221, and Vo denotes a transfer rate (reproduction rate) of the all combined data supplied from the track buffer 221 to the decoders 64, 65, 66. The read-out rate Vr depends on a linear speed of the disc, and the reproduction rate Vo is variable in response to a reproduced picture (scene). The data is read from the disc by an error correction (ECC) block unit. In the DVD-ROM, one error correction block corresponds to 16 sectors as shown in FIG. 14. FIG. 15 shows increase and decrease of a data input into the track buffer 221 at a time when the interleaved block is reproduced in a worst case. At this time, the jumping over the interleaved unit on the recording track is executed, and further the data is read and reproduced with respect to the interleaved unit which is a jumping end. In the worst case, the reading of the interleaved unit is started in a state in which the track buffer is empty, and the jumping to the next interleaved unit is performed after the reading ends. The top sector of the interleaved unit is a last sector of an ECC block, and the last sector of the interleaved unit is the top sector of the ECC block. That is, remaining parts of two ECC blocks are not valid data. A read-in time Te of one ECC block is b/Vr. Here, Vr denotes a transfer rate (e.g., 11 Mbps) at a reference speed, and b denotes a data size (e.g., 262,144 bits) of one ECC block. In FIG. 15, Vr denotes a transfer rate of data supplied from the error correction circuit 209 to the track buffer 221 (since error correction is executed every error correction block, an operation actually becomes intermittent in some case, and therefore the rate indicates an average transfer rate including an intermittent time), and Vo is a transfer rate of all combined data supplied from the track buffer 221 to the decoders 64, 65, 66. Moreover, Tj denotes a jumping time, and includes a time to seek a track, and accompanying necessary rotation waiting time (latency time), and Tj is given by a table depending on a jumping distance. With respect to the given jumping distance, a maximum waiting time depends on a position on the disc where the jumping occurs. The table shows a worst case in consideration of all the positions of the disc. Furthermore, Bx denotes an amount of data remaining in the track buffer 221 at a time (time t4) when the jumping is started.

A curve showing the data size in FIG. 15 indicates that the data is accumulated in the track buffer 221 at an accumulation ratio with a slope (Vr−Vo) from time t2. The curve indicates that the data size of the track buffer 221 turns to zero at time t6. The data of the track buffer 221 decreases at a decrease ratio of slope (−Vo) from time t3, and turns to zero at time t6.

The following is derived from this curve. The following is a condition on which the data is continuously output from the track buffer 221, that is, a condition on which the data is supplied to the decoders 64, 65, 66 without being interrupted:

Bx≧Vo(Tj+3Te) (1)

where Bx denotes the data size in the track buffer 221 at the jumping start time.

Moreover, the following size (ILVU_SZ) (sector) of the interleaved unit assures seamless jumping at a time when the jumping distance from the interleaved unit and the reproduction rate Vo are given:

ILVU_{—}SZ≧{(Tj×Vr×10⁶+2b)/(2048×8)}×Vo/(Vr−Vo) (2)

Next, a necessary capacity of the track buffer 221 will be studied. In many cases, the size ILVU_SZ of the interleaved unit is larger than a minimum value allowed on a certain condition. Moreover, Vo has a value smaller than an upper-limit value of MAX_Vo allowed with respect to the jumping distance. These factors bring about the discontinuance of the read because the track buffer 221 is filled. The read discontinuance is called kickback. Since Vr is constantly larger than MAX_Vo in the player, the kickback frequently occurs. When this kickback occurs immediately before the jumping, the player requires an extra time for an accessing the next ILVU. Even in this case, the track buffer 221 has to have a sufficient capacity in order to supply the data continuously. The capacity of the track buffer 221 is preferably a capacity with which the output data of the track buffer 221 is not interrupted, even when the recording apparatus performs a kickback operation, and subsequently the jumping is performed with respect to the interleaved unit. The kickback is a state in which pickup waits for the read while the disc rotates once. After the disc rotates once, a read position is sought in an adjacent track.

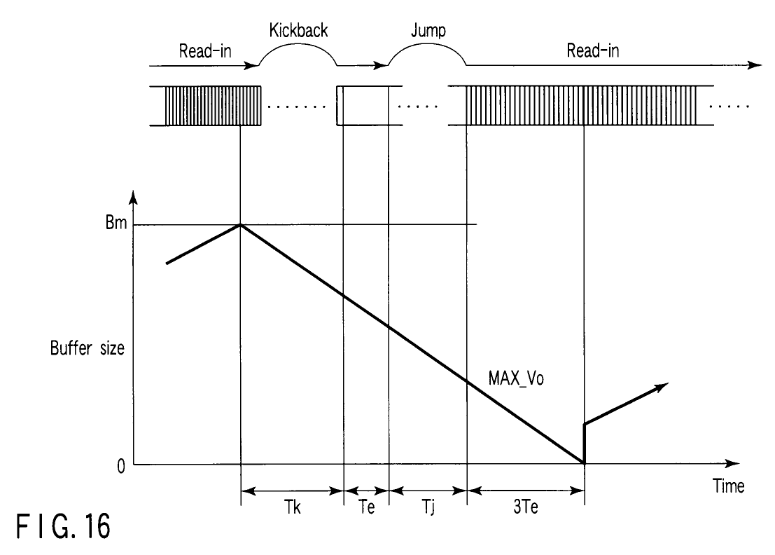

FIG. 16 shows a time when the kickback operation is performed in the recording apparatus, and subsequently a maximum class of jumping operation is performed, and a situation in which data is reduced in the track buffer 221. Assuming that the size of the track buffer 221 is Bm, a kickback time (corresponding to a one rotation time of the disc) is Tk, a read time (24 msec, i.e., 0.024 sec.) of one ECC block is Te, a jumping time (track seeking time tj plus latency time Tk) is Tj, and a maximum read-out rate of the decoder in the interleaved block is Voₘₐₓ, the capacity of the track buffer 221 requires the following condition in order to assure continuous data transfer from the track buffer in a case where the jumping operation is performed by a maximum distance immediately after completion of the kickback operation in the recording apparatus:

Bm≧{(2Tk+tj+4Te)×Voₘₐₓ×10⁶}/(2048×8) (3)

It is seen from the above that the required size of the track buffer 221 depends on Tk, tj, Te of the recording apparatus, and tj depends on performance of a seeking operation. It is also seen that Tk and Te depend on the rotation speed of the disc.

The foregoing explanation is about the jump operation of the interleaved system used in realization of multi-angle function, and the same principle is applied in seamless reproduction of video when jumping between two arbitrary points such as jumping in DVD Video Recording system. In this case, actually, it is not interleaved block ILVU, but it may be assumed that the ILVU is recorded on a disk at a distance, and is reproduced continuously. In the picture-in-picture display, when the main video and the sub-video are reproduced simultaneously from the disk, two VOBs, for example, VOB A and VOB B must be reproduced at the same time. However, actually only one VOB can be read from the disk, and while reading one VOB, the data of the other VOB must be stored in the track buffer memory. Therefore, VOB A is read first, and VOB B is read later, and necessary reproduction data until it is ready to read VOB A again is stored in the track buffer while reading the VOB A, and by jumping for reading the VOB B, the VOB B is read, and jumping again to the reading point of next VOB A, the VOB A is read. Concerning the VOB B, the same action as in reading of VOB A is conducted. Meanwhile, when the VOB A and VOB B are finely divided and disposed alternately as in the interleaved system, the jumping action is not needed, and the data can be read alternately by reading the disk continuously.

As explained in relation to the prior art, recently, the household display appliances for high definition (HD) video are spreading widely, and the information recorded medium is also demanded to be applicable to high definition (HD) video. In the conventional DVD-Video standard, a movie of standard definition (SD) with standard length can be recorded in one layer of DVD-ROM, but as a result of recent progress in moving image compression technology, high definition (HD) video having 4× pixel density can be compressed to an average data quantity of about 2×, and hence a movie can be recorded in two layers of a DVD-ROM. In other words, the data size is 2× on average, or 3× in part. Therefore, the data rate Vo to be supplied into the decoder from the buffer memory is 3 times that of the prior art, and the data rate Vr to be read from the disk and supplied into the buffer memory is required to be 3 times that of the conventional rate.

Meanwhile, the DVD-ROM and many other optical disks are constant in linear recording density, and thus in order to read the information at a constant data rate Vr, it is required to change the rotational speed depending on the radius. This is realized by controlling the spindle motor, but when the torque of the spindle motor is constant, the time required for changing the rotational speed at the same radius is nearly proportional to the data rate Vr and the jump distance. Actually, as the general characteristics of the motor, as the rotational speed is higher, the resistance of viscosity and the wind loss increase. Thus, as the rotational speed becomes higher, the torque usable for increase in rotational speed decreases.

Incidentally, in the HD applicable appliances, seamless reproduction of contents recorded at arbitrary positions not determined in the conventional DVD-Video standards is demanded, and to realize this, it is required to realize seamless reproduction even when jumping a long distance. Mainly in the Video Recording standard for recording video of television broadcast or video camera in a recording type optical disk, for editing operation after recording, jumping between two arbitrary points within a specified time is still required.

In the conventional DVD-Video standard, even in the case of jumping over such a long distance, it is possible to follow up the disk rotational speed by the end of the jump. However, when the disk rotational speed is 3× as mentioned above, it is difficult to increase the torque of the spindle motor, and thus even after the jumping, it is difficult to keep the linear velocity, that is, the reading speed constant. In particular, in the portable appliance, since it is operating on a battery, the available peak electric power is limited. To increase the peak electric power, the battery size must be increased, that is, the appliance is increased in size and weight, and the commercial value is sacrificed. It is hence not realistic to increase the motor torque.

Specifically, when jumping from the outer area to the inner area in reproduction, the disk rotational speed must be increased, but if not possible to follow up the speed due to lack of torque, the data rate Vr may be lower than the assumed standard value, the buffer memory may be vacant, and the video may be interrupted.

In the present DVD-ROM drive capable of reproducing at high speed, the disk recorded at a constant linear velocity (CLV) may be rotated at a constant angular velocity (CAV), instead of the constant liner velocity. In this case, since the reading data rate Vr is 3× or more, if the linear velocity of the innermost area is 3×, the linear velocity of the outermost area is about 7.3×. The problem described above is solved by employing this system.

However, in the existing DVD-ROM, the reading speed guaranteed by the standard is 1× speed, and the mechanical characteristics such warp or eccentricity of disk are determined by assuming reproduction at 1× speed. If the disk is warped or eccentric, the objective lens actuator must generate a force for following up, but the acceleration generated by warp or eccentricity is proportional to the square of the linear velocity. For example, at 8× speed, it is required to generate a force of 64 times of 1× speed. Realistically, it is difficult to generate such enormous force. Therefore, even in a drive capable of reproducing at high speed, fast reproduction is difficult due to mechanical properties such as warp of disk, and the reproducing speed is lowered in such a case. In other words, as long as the warp or eccentricity of the disk is small enough as compared with the standard, fast reproduction is possible. However, if it is large, it is impossible to follow up, and the reproducing speed must be lowered.

In a disk capable of recording high definition (HD) video, the maximum values of warp and eccentricity of the disk must be determined so as to reproduce at 3× speed, but considering the present disk manufacturing technology, aging effects, cost, and the performance and cost of optical disk device, it is not realistic to determine the standard so as to reproduce by the CAV system in which the innermost area is 3× speed, and the problem described above cannot be solved by reproducing by the CAV system.

The embodiment is devised to solve these problems, and it is hence an object thereof to provide an optical disk apparatus capable of realizing the same effect as keeping the data reading rate higher than a specific level.

In the embodiment, in order to reproduce high-definition video demanding a higher data transfer rate than a specific rate, the disk 201 must be rotated at a linear velocity of about 3 times the conventional speed. In such fast rotation, as the spindle motor 204, the conventional brush motor has a problem in terms of the brush life, and it is preferred to use a brushless motor. The brushless motor is required to generate a changeover timing of direction of current flowing in the motor coil, and generally has a Hall element, by the use of which it is possible to output a pulse of frequency proportional to the motor rotational speed, and the rotational speed can be detected by this pulse signal.

In this system, even when jumping a long distance, the optical head may be moved at a conventional speed regardless of the degree of increase in the disk rotational speed, and even if the changing time of the disk rotational speed exceeds the moving time of the optical head, taking more than the maximum jump time Tj assumed in the standard, seamless reproduction is realized by properly changing the data reading method from the optical disk.

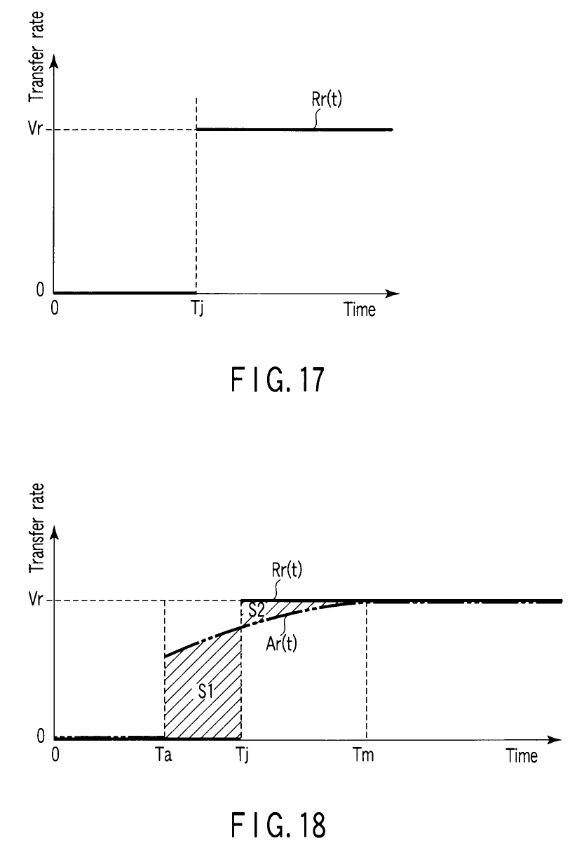

FIG. 17 is a diagram of data transfer rate from the disk assumed in the prior art. Supposing the jump time from start of jump to be Tj, the data can be read at desired data rate Vr (so that the change of disk rotational speed may be completed). Usually, Tj varies with the jump distance, and thus the value of Tj is changed depending on the jump distance, and the size of the data to be read before the jump is determined (the size of ILVU in the case of interleaved unit). On the basis of such calculation, data is recorded on the disk. Therefore, in the actual reproducing apparatus, the data rate is not specified (being lower than Vr) before passing of the jump time Tj, but the data can be read, and after passing the jump time Tj, the data rate must be securely more than the specified rate Vr. However, when the DVR-ROM is reproduced at 3× speed as mentioned above, the change of motor rotational speed is not completed within the jump time, and it is difficult for the transfer rate to reach the Vr immediately after the jump.

FIG. 18 shows a situation likely to occur in 3× speed reproduction. This is a case of jump from outer area to inner area. The thick solid line indicates the data rate Rr(t) assumed in this standard (same as in FIG. 17), and the chain double-dashed line shows a model of data rate Ar(t) actually readable by the optical disk device. When the jump time Tj is sufficiently long, for example, 2 seconds, the seek action is over before passing the jump time Tj, and the data can be read at lower data rate Ar(t) than Vr. At time Tm after passing the jump time Tj, the data rate Ar(t) reaches Vr. From time Ta to time Tm, the data rate Ar(t) is supposed to increase monotonously.

In such characteristics of the optical disk device, when starting data reading from the disk at time Tj according to the model in FIG. 18, the data cannot be read for the portion of S2 determined from the following formula (4). In FIG. 18, S2 corresponds to an area of the region enclosed by the lines indicating the data rates Rr(t) and Ar(t) and time Tj.

S2=∫_{Tj}^{Tm}{Rr(t)−Ar(t)}dt (4)

As a result, the data necessary for next jump is not accumulated in the track buffer memory, and seamless reproduction is disabled.

In this system, accordingly, after start of a jump, even before passing the jump time (the data rate reaching the specified rate), as soon as the head moves to a desired track and the optical disk device is ready to read data, the reading is started regardless of the data rate. If this reading start time Ta is before passing the jump time Tj, the data in the quantity of S1 shown in the formula below is accumulated in the track buffer memory before reaching the jump time Tj. In FIG. 18, S1 corresponds to an area of the region enclosed by the lines indicating the data reading start time Ta, time Tj, and data rates Ar (t), Rr (t).

S1=∫₀^{Tj}{Ar(t)−Rr(t)}dt≧0 (5)

In this formula, integration starts from 0, but since from 0 to time Ta, the data rates Ar(r) and Rr(t) are both zero, the result is the same even if integrated from time Ta.

Herein, when the following equation is established, it is equivalent to when the data is read from the disk at data rate Rr(t) from time Tj, and when the following formula is satisfied, it is better than the assumed condition, and thus the seamless reproduction is done without problem.

S1≧S2 (6)

Summing up formula (4) to formula (6), it is possible to express in the following formula.

S=∫₀^{Tm}{Ar(t)−Rr(t)}dt≧0 (7)

Regarding the memory which is provided for accumulating the data S1 being read before the jump time Tj, since the data accumulated for reproduction during the jump is sent to the decoder in the jump period, the vacancy increases in the track buffer until reaching the jump time Tj. The data for the portion of S1 is accumulated in this vacant area, and hence the required track buffer memory capacity is not increased.

Therefore, in the optical disk device conforming to formula (7), after start of the jump, the reading is started as soon as the optical disk is ready to read the data, and it is controlled to transfer the data to the track buffer. As a result, even if the data rate is lower than Vr upon passing of the jump time Tj, the seamless reproduction can be done without problem.

The interval between a jump and a next jump is not particularly defined in this system because the data insufficient when being read after passing Tj is preliminarily read in before passing the jump time Tj, and next jump may be started before time Tm. Quite naturally, as long as Tj is determined, the jump interval is Tj or more.

If not conforming to the reproduction method of the embodiment, the value of the jump time Tj must be set at a time longer than the time Tm by which the data rate reaches the value Vr, and (1) the data size to be read before the jump is enormous, and fine editing is difficult, (2) the size of ILVU is huge, and the angle changeover timing during reproduction decreases, and the operability is lowered, and (3) a large track buffer size is needed, and the manufacturing cost of the optical disk reproducing apparatus is increased. All these problems are solved by the reproduction method of the embodiment.

The optical disk device is also reduced in size because a disk motor of a huge torque is not needed, and hence the power consumption and manufacturing cost may be saved.

According to the system of the embodiment, in the case of conventional DVD Video Recording for reproducing the disk at 1× speed, for example, the jump time Tj is 1.5 seconds, but in the case of HD applicable Video Recording system for reproducing at 3× speed, only by increasing the Tj slightly to 2 seconds, seamless reproduction is possible in the DVD system of reproduction at 3× speed. If reproduced at 3× speed, only the value of Tm is increased, and the value of Ta does not exceed the value at the jump time Tj in DVD Video Recording. This is because Ta is mostly the moving time of the optical head, and is regarded not related to the disk rotational speed. Still more, since the rotational speed is increased, the rotational wait time is advantageously decreased. Therefore, at least 0.5 second before the jump time Tj, accumulation in the buffer memory can be started. As for the value of Tm, on the other hand, at worst, it may be assumed to exceed 4 seconds. When the Ta is small, the Tm may be long, while when the Ta is long, the Tm must be short. The balance between Ta and Tm may be freely set in each optical disk device, and the design has a degree of freedom for change depending on the circumstance. If this system is not employed, the Tm must be equal to or smaller than the Tj, and it is very difficult to realize.

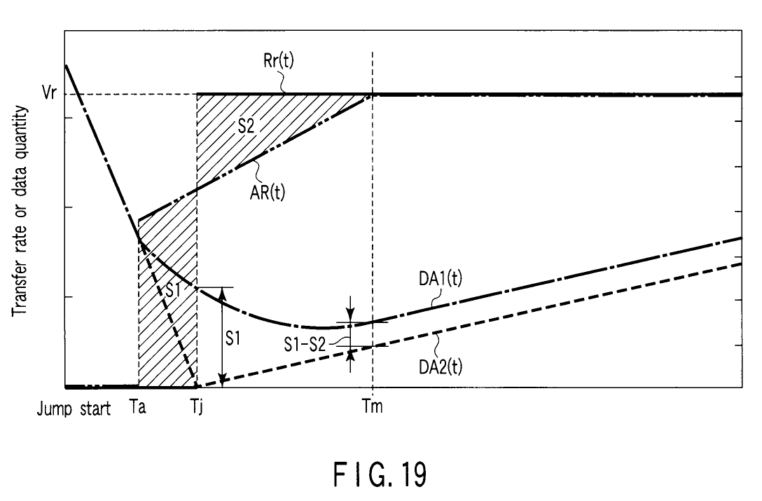

To realize this system, the reproduction program of the optical disk must be designed to start reading of data into the track buffer, when the optical disk reproducing apparatus is ready to read the data after the jump is instructed to the optical disk reproducing apparatus. The optical disk device must be manufactured to have the performance satisfying the formula (7). Aside from these two conditions, new conditions do not occur. FIG. 19 shows an example of operation of jumping between two arbitrary points of the disk or long-distance jumping in picture-in-picture display in an optical disk reproducing apparatus operating on the system of the embodiment, in which the motor torque is insufficient, the rotational speed is not increased up to the desired rotational speed after the end of the jump, and the desired transfer rate is not assured. FIG. 19 is similar to FIG. 18, except that the data quantity DA1(t) to be accumulated in the track buffer in the optical disk reproducing apparatus of the embodiment, and the data quantity DA2(t) to be accumulated in the track buffer in the optical disk reproducing apparatus of the prior art are added. In the long-distance jumping, the jump time Tj is usually set at 2 seconds or more. In 3× speed reproduction, the reading time Te of one ECC block (the reading time in the above example) is about 8 ms, and it is extremely short as compared with Tj in long-distance jumping, and thus Te is ignored in this diagram.

The axis of abscissa denotes the time passed after start of jump, and the left side shows the start of jump. The axis of ordinate represents the quantity or size of data stored in the track buffer memory, or the data transfer rate.

If operating according to a conventional model due to enough motor torque, data transfer from the disk to the track buffer memory is started from the jump time Tj, and thus the data of the track buffer memory is sent to the decoder up to Tj. Therefore, as indicated by the characteristic DA2(t), the data continues to decrease, and begins to increase monotonously from Tj. Suppose, in spite of the reading data rate being lower than Vr at Tj, data reading is started from Tj. When the reading data rate is Vo or lower at Tj, there is no data in the track buffer memory at Tj, and thus the reproduction is interrupted immediately, and seamless reproduction fails. When the reading data rate at Tj is Vo or higher and Vr or lower, the data is not insufficient at the time of this jumping, and seamless reproduction is enabled. However, the quantity of data accumulated in the track buffer memory is smaller than assumed, and thus the data is insufficient at a next jump, and seamless reproduction may fail.

In this embodiment, since the motor torque is insufficient, and the data rate is Vr or lower at Tj, as indicated by characteristic DA1(t), the disk reading is started from Ta before Tj, and the data is sent into the track buffer memory. The data in the track buffer memory begins to decrease immediately after start of jump, but since disk reading is started from Ta in this example, the rate of decrease is smaller. Therefore, at the time of Tj, as compared with the conventional model, the quantity of data stored in the track buffer memory is increased, and thus the seamless reproduction does not fail at Tj.

The increment of the data quantity accumulated in the track buffer memory at the time of Tj over the conventional model is equivalent to S1. The rate of decrease in data in the track buffer memory declines along with elevation of reading data rate, and when exceeding the data transfer rate Vo sent to the decoder from the track buffer memory, it begins to increase. From the time Tm when the reading data rate from the disk reaches Vr, the rate of increase in data in the track buffer memory is equal to the rate of increase in the conventional model. Therefore, in the graph, the lines are parallel. At the moment of Tm, the increment of the data quantity in the track buffer memory over the conventional model is equivalent to S1-S2.

In this example, since S1 is greater than S2, at Tm, the data quantity in the track buffer memory is larger than in the conventional model. Supposing S1 to be equal to S2, at Tm, the data quantity in the track buffer memory is the same as in the conventional model. Therefore, at the time of a next jump, the data to be sent to the decoder is not insufficient, and seamless reproduction is enabled.

According to the system of the embodiment, without changing the method of determining configuration of data in the disk, by adding a simple condition of setting Ta and Tm to satisfy the relation of:

S=∫₀^{Tm}{Ar(t)−Rr(t)}dt≧0

seamless reproduction can be performed by using an optical disk difficult to maintain a specified data transfer rate immediately after jumping.

As described herein, according to the embodiment, since the data can be accumulated in the memory by starting data reading before passing the jump time after start of the jump, even if the reading rate after passing the jump time is lower than a specified rate, it is possible to prevent a failure of seamless reproduction arising from interruption of video due to loss of data in the memory.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk reproducing apparatus which reproduces an optical disk which stores discrete items of data to be read at a specific or higher rate,
wherein after starting jumping between the discrete items of data, data reading is started at the specific or lower rate from a time Ta before passing a specific jump time Tj, and when a data reading rate reaches the specific rate at a time Tm after passing of the jump time Tj, an amount of data read from the time Ta to the time Tj is equal to or larger than a difference between an amount of data read at the specific rate from the time Tj to the time Tm and an amount of data read at the specific or lower rate from the time Tj to the time Tm.

2. The optical disk reproducing apparatus according to claim 1, wherein the time Ta is later than a time when a head reaches a jump destination position.

3. An optical disk device which reads data from an optical disk which stores discrete items of data to be read at a specific or higher rate,
wherein after starting jumping between the discrete items of data, a head reaches a jump destination position at a time Ta before passing a specific jump time Tj, data reading is enabled, and at a time Tm after passing the jump time Tj, data reading at the specific rate is enabled.

4. The optical disk device according to claim 3, wherein an amount of data read from the time Ta to the time Tj is equal to or larger than a difference between an amount of data read at the specific rate from the time Tj to the time Tm and an amount of data read at the specific or lower rate from the time Tj to the time Tm.

5. An optical disk reproducing apparatus which reproduces an optical disk by using an optical disk device which reads data from an optical disk which stores discrete items of data to be read at a specific or higher rate,
wherein after start of jumping, regardless of transfer rate, reading is started from a time Ta when a head reaches a jump destination position.

6. The optical disk reproducing apparatus according to claim 5, wherein the optical disk device is capable of reading data at the specific rate at a time Tm later than a specific time Tj.

7. The optical disk reproducing apparatus according to claim 6, wherein an amount of data read from the time Ta to the time Tj is equal to or larger than a difference between an amount of data read at the specific rate from the time Tj to the time Tm and an amount of data read at the specific or lower rate from the time Tj to the time Tm.
